(19) United States
(12) Patent Application Publication
(10) Pub. No.: US 2008/0225034 A1
(43) Pub. Date: Sep. 18, 2008

(54) Image sticking erasing circuit and method for using the same

(75) Inventors: Wen Chia Pi, Hsinchu City (TW); Yung Ching Chang, Hsinchu City (TW); Yen Kuo Lo, Hsinchu City (TW); Ko Ching Su, Hsinchu City (TW)

Correspondence Address: OLIFF & BERRIDGE, PLC, P.O. BOX 320850, ALEXANDRIA, VA, 22320-4850, US

(73) Assignee: ADVANCED ANALOG TECHNOLOGY, INC., Hsinchu (TW)

(21) Appl. No.: 11/730,156

(22) Filed: Mar. 29, 2007

(30) Foreign Application Priority Data
Feb. 14, 2007 (TW) 096105416

(51) Int. Cl. G06F 3/038

(52) U.S. Cl. 345/212

(57) ABSTRACT

The image sticking erasing circuit includes a detection circuit and a switching circuit connected to the detection circuit. The detection circuit is for use in detecting a first voltage signal, which closely follows the variation of the voltage source, and a reference voltage, which loosely follows the variation of the voltage source. When the detection circuit determines that the first voltage signal is lower than a first threshold value, the switching circuit switches the gate of a driving transistor to a second voltage signal, which loosely follows the voltage source. When the detection circuit determines that the reference voltage signal is lower than a second threshold value, the switching circuit switches the gate of a driving transistor to a low voltage state.

### BACKGROUND OF THE INVENTION

1. Field of the Invention

The present invention relates to an image sticking erasing circuit, and more particularly, to an image sticking erasing circuit which maintains gate voltage upon shutdown.

2. Description of the Related Art

Most LCD monitors in the market leave image-sticking problem upon shutdown. FIG. 1 is a pixel array and control circuit of prior art LCD monitors, where the gate driving circuit 11 is for use in controlling gate signals of driving transistors 16. When the gate voltage of the driving transistors 16 remains in a high voltage state, the data driving circuit 12 will charge electrons into storage capacitors 14 of the pixel array 13, or discharge electrons from the storage capacitors 14. Because the storage capacitor 14 connects to the liquid cell 15 in a parallel manner, electronic charge or discharge of the storage capacitor 14 simultaneously occurs with image data read and write of the liquid cell 15. Upon the voltage source V_{DD} is cut off, the gate voltage V_{GH} of the driving transistor 16, which is responsible for controlling read or write operations of the pixel array, will enter a low voltage state. Because the electrons of the storage capacitor 14 cannot be discharged upon cutoff, the image-sticking problem occurs.

FIG. 2 shows a timing chart of prior art image sticking problem. When the voltage source V_{DD} is suddenly cut off, as indicated in mark 21, the gate voltage V_{GH} will enter a low voltage state, as indicated in mark 22. Because the electronic charge of the storage capacitor 14 cannot be discharged due to the entrance of the low voltage state of the gate voltage V_{GH}, the image-sticking problem occurs.

Taiwan patent application Nos. 94125836 and 93137423 disclose a prior art image sticking erasing circuit, which forces the gate voltage to remain in a high-voltage state for a long period of time when the voltage source V_{DD} is suddenly cut off. Even though the prior art method can erase image sticking problem, some other noises will enter the storage capacitor during that period and thus generate other noises.

### SUMMARY OF THE INVENTION

The image sticking erasing circuit and the method thereof of the present invention is for use in effectively erasing image sticking problem upon shutdown of the display monitor.

The image sticking erasing circuit, according to an embodiment of the present invention, includes a first detection circuit, a second detection circuit, a first switch, and a second switch. The first detection circuit is configured to detect a first voltage signal sharply following a voltage source. The second detection circuit is configured to detect a reference voltage signal bluntly following the voltage source. The first switch connects to a gate voltage and a second voltage signal bluntly following the voltage source. The second switch connects to a gate voltage and a low voltage source. The first switch is turned on and the second switch is turned off when the first detection circuit determines that the first voltage signal is lower than a first threshold value. The second switch is turned on and the first switch is turned off when the second detection circuit determines that the reference voltage signal is lower than a second threshold value.

The image sticking erasing method, according to an embodiment of the present invention, includes the steps of detecting a first voltage signal sharply following a voltage source and a reference voltage signal bluntly following a voltage source. When the first voltage signal is lower than a first threshold value, the gate of the driving transistor is switched to a second voltage signal bluntly following the voltage source. When the reference voltage signal is lower than a second threshold value, the gate of the driving transistor is switched to a low voltage source.

The monitor control circuit, according to an embodiment of the present invention, includes a storage capacitor, a driving transistor, a detection circuit, and a switch. The driving transistor includes a gate, where one end of the driving transistor connects to the storage capacitor. The detection circuit is configured to detect a first voltage signal sharply following a voltage source and a reference voltage signal bluntly following the voltage source. The switch connects to the detection circuit, where the gate of the driving transistor is switched to a second voltage signal bluntly following the voltage source when the detection circuit determines that the first voltage signal is lower than a first threshold value. The gate of the driving transistor is switched to a low voltage source when the detection circuit determines that the reference voltage signal is lower than a second threshold value.

### BRIEF DESCRIPTION OF THE DRAWINGS

The invention will be described according to the appended drawings in which:

FIG. 1 is a hint diagram of a prior art pixel array and control circuit of an LCD monitor;

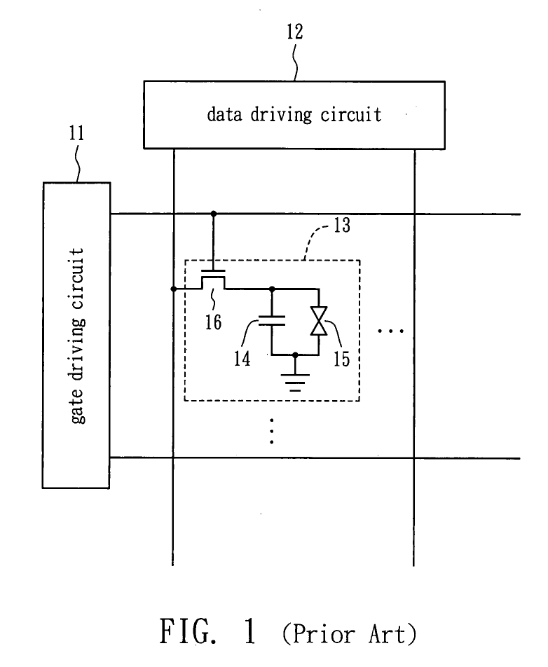

FIG. 2 is a timing chart of a prior art gate voltage upon shutdown;

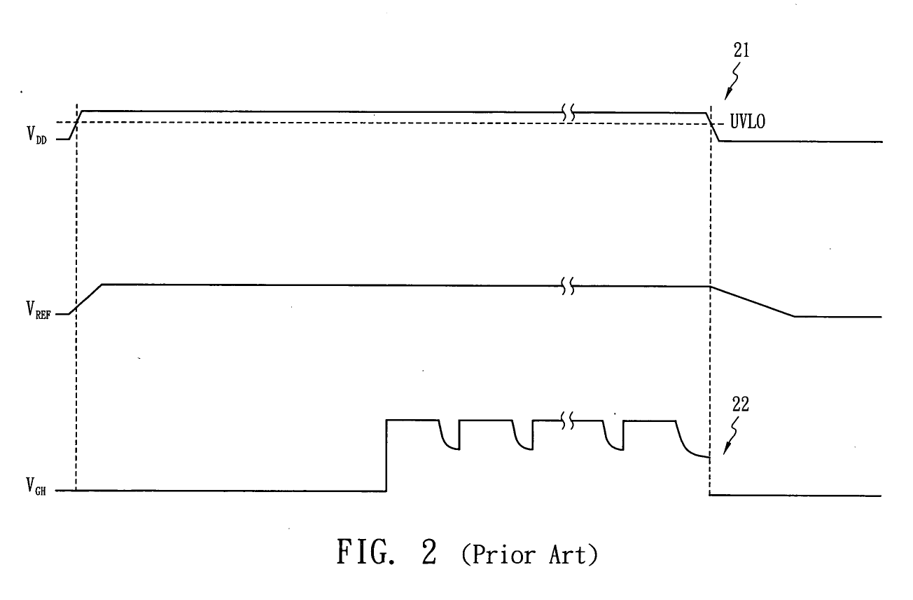

FIG. 3 is a schematic view of the image sticking erasing circuit according to an embodiment of the present invention;

FIG. 4 shows a second voltage signal captured from a charge pump circuit;

FIG. 5 is a timing chart of the gate voltage of the invention upon shutdown; and

FIGS. 6(a)-6(d) show schematic diagrams of the first and second switches according to an embodiment of the present invention.

### PREFERRED EMBODIMENT OF THE PRESENT INVENTION

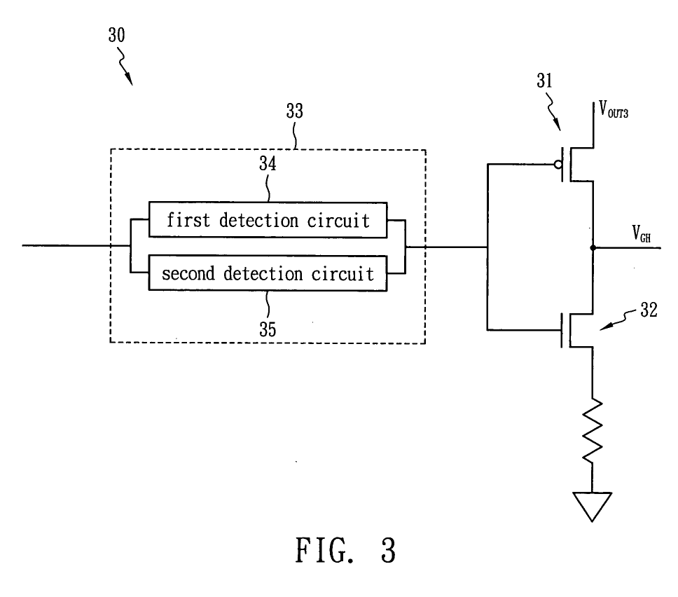

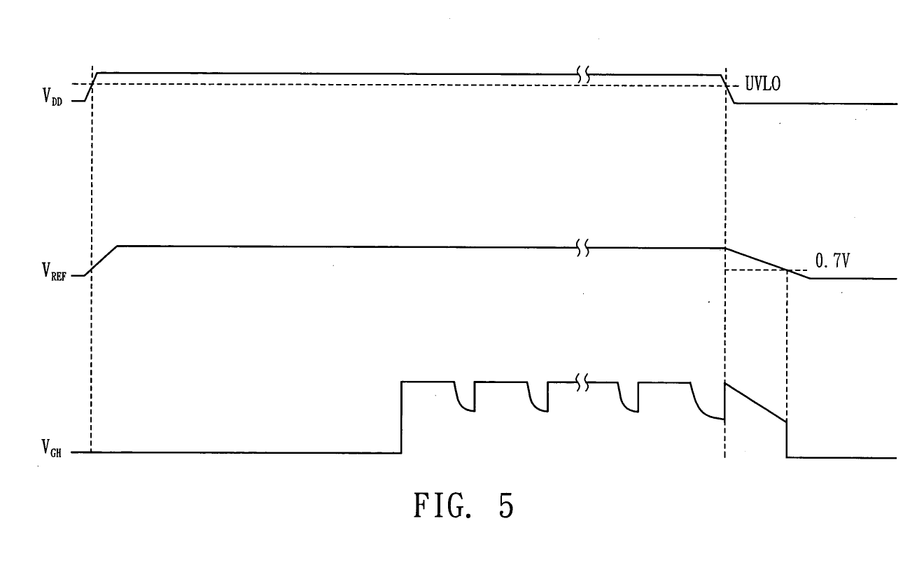

FIG. 3 shows an image sticking erasing circuit 30 according to an embodiment of the present invention, which includes a detection circuit 33, a first switch 31 and a second switch 32. The detection circuit 33 includes a first detection circuit 34 and a second detection circuit 35. The first detection circuit 34 is for use in detecting a first voltage signal sharply following a voltage source, and the second detection circuit 35 is for use in detecting a reference voltage signal bluntly following the voltage source. When the first detection circuit 34 determines that the first voltage signal is lower than a first threshold voltage, e.g., lower than UVLO level in FIG. 5, a control signal is outputted in order to turn on the first switch 31 and turn off the second switch 32. The source and drain of the first switch 31 are connected to a second voltage signal, e.g., a charge pump circuit, bluntly following the voltage source, and the gate voltage V_{GH}, respectively. Upon switching to the first switch 31, the second detection circuit 35 continuously detects a reference voltage signal bluntly following the voltage source. Generally speaking, some reference voltages will be designed in an analog circuit in order to cooperate with different modules. The present invention could pick some reference voltage signals bluntly following the voltage source. When the second detection circuit 35 determines that the reference voltage signal is lower than a second threshold value, e.g., lower than 0.7 Volts as shown in FIG. 5, a control signal is outputted to turn on the second switch 32 and turn off the first switch 31. The source and drain of the second switch 32 connect to a low voltage level, e.g., grounding, and the gate voltage V_{GH}.

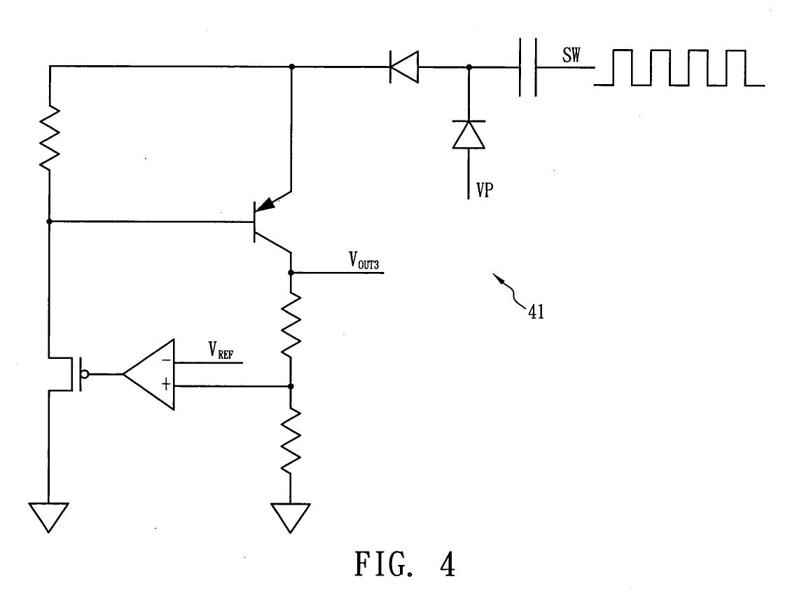

FIG. 4 shows a second voltage signal captured from a charge pump circuit according to an embodiment of the present invention. Because the charge pump circuit 41 includes an electron-storing element, e.g., capacitor or comparing amplifier, a high voltage can be retained even though the voltage source has been cut off.

FIG. 5 is a timing chart of the gate voltage of the invention upon shutdown, where V_{DD} represents a voltage source, V_{REF} represents a reference voltage, and V_{GH} represents a gate voltage. When V_{DD} is lower than UVLO level, the gate voltage V_{GH} connects to a second voltage signal captured from the charge pump circuit 41 through the first switch 31. Even though the second voltage signal is slightly lowered due to the cutoff of the voltage source, the driving transistor 16 of the pixel array of the LCD monitor can still be enabled in order to discharge the storage capacitor 14, thus the present invention can solve the image-sticking problem.

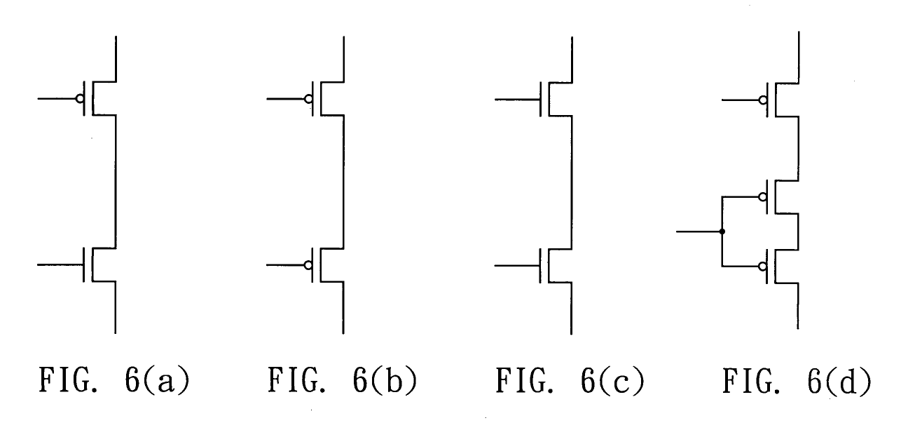

FIGS. 6(a)-6(d) show schematic diagrams of the first switch 31 and second switch 32 according to an embodiment of the present invention. The first switch 31 and the second switch 32 of the present invention could be P-type as well as N-type transistors, P-type as well as P-type transistors, N-type as well as N-type transistors, P-type as well as a combination of P-type transistors. The present invention does not limit the specific structure of the first and second switches.

The above-described embodiments of the present invention are intended to be illustrative only. Numerous alternative embodiments may be devised by persons killed in the art without departing from the scope of the following claims.

What is claimed is:

1. An image sticking erasing circuit, comprising:
a first detection circuit configured to detect a first voltage signal sharply following a voltage source;
a second detection circuit configured to detect a reference voltage signal bluntly following the voltage source;
a first switch connected to a gate voltage and a second voltage signal bluntly following the voltage source; and
a second switch connected to the gate voltage and a low voltage source;
wherein the first switch is turned on and the second switch is turned off when the first detection circuit determines that the first voltage signal is lower than a first threshold value, the second switch is turned on and the first switch is turned off when the second detection circuit determines that the reference voltage signal is lower than a second threshold value.

2. The image sticking erasing circuit of claim 1, wherein the second voltage signal is captured from a charge pump circuit.

3. The image sticking erasing circuit of claim 1, wherein the first switch is a P-type transistor and the second switch is an N-type transistor.

4. The image sticking erasing circuit of claim 1, wherein the first switch is a P-type transistor and the second switch is a P-type transistor.

5. The image sticking erasing circuit of claim 1, wherein the first switch is an N-type transistor and the second switch is an N-type transistor.

6. The image sticking erasing circuit of claim 1, wherein the first switch is a P-type transistor and the second switch is a combination of P-type transistors.

7. A monitor control circuit, comprising:
a storage capacitor;
a driving transistor having a gate, wherein one end of the driving transistor connects to the storage capacitor;
a detection circuit configured to detect a first voltage signal sharply following a voltage source and a reference voltage signal bluntly following the voltage source; and
a switch connected to the detection circuit, wherein the gate of the driving transistor is switched to a second voltage signal bluntly following the voltage source when the detection circuit determines that the first voltage signal is lower than a first threshold value, the gate of the driving transistor is switched to a low voltage state when the detection circuit determines that the reference voltage signal is lower than a second threshold value.

8. The monitor control circuit of claim 7, wherein the second voltage signal is captured from a charge pump circuit.

9. A method for erasing image sticking for use in controlling a driving transistor of a display monitor, comprising the steps of:
detecting a first voltage signal sharply following a voltage source and a reference voltage signal bluntly following the voltage source;
switching the gate of the driving transistor to a second voltage signal bluntly following the voltage source when the first voltage signal is lower than a first threshold value; and
switching the gate of the driving transistor to a low voltage state when the reference voltage signal is lower than a second threshold value.

10. The method for erasing image sticking of claim 9, wherein the second voltage signal is captured from a charge pump circuit.
